(19) United States
(12) Patent Application Publication
(10) Pub. No.: US 2020/0233965 A1
(43) Pub. Date: Jul. 23, 2020

(54) INFORMATION PROCESSING APPARATUS, INFORMATION PROCESSING SYSTEM, SECURITY ASSESSMENT METHOD, AND SECURITY ASSESSMENT PROGRAM

(71) Applicant: NEC CORPORATION, Tokyo (JP)

(72) Inventor: Masaki INOKUCHI, Tokyo (JP)

(73) Assignee: NEC CORPORATION, Tokyo (JP)

(21) Appl. No.: 16/651,898

(22) PCT Filed: Sep. 29, 2017
(86) PCT No.: PCT/JP2017/035713

§ 371 Date: Mar. 27, 2020

(51) Int. Cl. G06F 21/57; G06F 21/56; G06F 21/60; G06F 21/71

(52) U.S. Cl. CPC G06F 21/577; G06F 21/71; G06F 21/606; G06F 21/567

(57) ABSTRACT

To implement a security assessment system capable of assessing an attack path including an air gap path, there is provided an information processing apparatus including a system configuration detector that detects at least two hosts included in a system and a communication link between the at least two hosts, an air gap path detector that detects, among the at least two hosts, a pair of hosts between which there is no communication link but data movement can occur, and a security assessment unit that performs security assessment using a detection result by the system configuration detector and a detection result by the air gap path detector.

### TECHNICAL FIELD

The present invention relates to an information processing apparatus, an information processing system, a security assessment method, and a security assessment program.

### BACKGROUND ART

In the above technical field, a paragraph [0064] and FIG. 5 of patent literature 1 disclose a security monitoring apparatus that monitors and detects a security problem such as vulnerability including malware infection, a virus, an illegal behavior in a networking environment, or a problem with IT asset management, and automatically isolates and monitors a terminal.

### CITATION LIST

### Patent Literature

Patent literature 1: Japanese Patent Laid-Open No. 2017-091493

### SUMMARY OF THE INVENTION

### Technical Problem

In the technique described in the above literature, however, it is impossible to perform assessment in consideration of a situation in which a host that cannot be reached no matter how communication links existing on a network are followed is attacked from a given host.

The present invention provides a technique of solving the above-described problem.

### Solution to Problem

One example aspect of the present invention provides an apparatus comprising:

a system configuration detector that detects at least two hosts included in a system and a communication link between the at least two hosts;

an air gap path detector that detects, among the at least two hosts, a pair of hosts between which there is no communication link but data movement can occur; and

a security assessment unit that performs security assessment using a detection result by the system configuration detector and a detection result by the air gap path detector.

Another example aspect of the present invention provides a method comprising:

detecting at least two hosts included in a system and a communication link between the at least two hosts;

detecting a pair of hosts between which there is no communication link but data movement can occur, among the at least two hosts; and

performing security assessment using a detection result obtained in the detecting the at least two hosts and a detection result obtained in the detecting the pair of hosts.

Still other example aspect of the present invention provides a program for causing a computer to execute a method, comprising:

detecting at least two hosts included in a system and a communication link between the at least two hosts;

detecting a pair of hosts between which there is no communication link but data movement can occur, among the at least two hosts; and

performing security assessment using a detection result obtained in the detecting the at least two hosts and a detection result obtained in the detecting the pair of hosts.

### Advantageous Effects of Invention

According to the present invention, it is possible to implement a security assessment system capable of assessing an attack path including an air gap path.

### BRIEF DESCRIPTION OF DRAWINGS

FIG. 1 is a block diagram showing an example of a security assessment system according to the first example embodiment of the present invention;

FIG. 2 is a view showing the configuration of a system as an evaluation target of a security assessment system according to the second example embodiment of the present invention;

FIG. 3 is a block diagram showing the configuration of the security assessment system according to the second example embodiment of the present invention;

FIG. 4 is a view showing a system layout used as an input document in the security assessment system according to the second example embodiment of the present invention;

FIG. 5 is a view for determining an air gap path by regarding an air gap path component 203 as a host in the security assessment system according to the second example embodiment of the present invention;

FIG. 6 is a flowchart illustrating the processing procedure of the security assessment system according to the second example embodiment of the present invention;

FIG. 7 is a block diagram showing the configuration of a system as an evaluation target of a security assessment system according to the third example embodiment of the present invention;

FIG. 8 is a view showing the operation manual of the system as the evaluation target of the security assessment system according to the third example embodiment of the present invention;

FIG. 9 is a flowchart illustrating the processing procedure of the security assessment system according to the third example embodiment of the present invention;

FIG. 10 is a block diagram showing the configuration of a system as an evaluation target of a security assessment system according to the fourth example embodiment of the present invention;

FIG. 11 is a view showing a practical use method of the security assessment system according to the fourth example embodiment of the present invention;

FIG. 12 is a flowchart illustrating the processing procedure of an air gap path information collection client according to the fourth example embodiment of the present invention; and

FIG. 13 is a flowchart illustrating the processing procedure of the security assessment system according to the fourth example embodiment of the present invention.

### DESCRIPTION OF EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

### First Example Embodiment

(Technical Premise)

In general, if a host accessible by an attacker in an initial state is different from a host as an attack target of the attacker, the attacker attacks the host as the attack target via a plurality of hosts in a system. Thus, it is necessary to be able to assess an attack via the plurality of hosts even in security assessment.

An existing security assessment system provides a function of extracting an order (attack path) in which hosts existing on a network in the system are attacked, and estimating a required attack time and the degree of possibility that an attack is made, and estimating damage if an attack is made. A communication link existing on the network may be wired or wireless.

A host that can be reached by following communication links on the network will simply be referred to as a “normal reachable host” hereinafter. Similarly, a host that cannot be reached no matter how communication links are followed will simple be referred to as a “normal unreachable host” hereinafter.

In the existing security assessment system, even if a given host is attacked and under the control of an attacker, this host cannot communicate with a normal unreachable host, and it is thus determined that no attack can be made.

In fact, however, an attack action of spreading malware infection via a portable storage medium or the like can be performed. For example, even if hosts A and B exist and there is no connection between hosts A and B on the network, if there exists a storage medium (a USB memory or the like) connected to both hosts A and B, malware infection may spread from one host to the other host via the storage medium. Note that in this specification, a path between hosts connected by a temporarily connected medium will be referred to as an “air gap path” hereinafter. A path between hosts connected by some communication link will be referred to as a “normal path” hereinafter.

No air gap path appears in network configuration information and the like collected from an actual apparatus, and thus the existing security assessment system cannot consider the air gap path.

Note that an air gap path can generally exist between normal reachable hosts. For example, when there exist hosts A and B between which some communication link exists, if there exists a storage medium connected to both hosts A and B, both a normal path and an air gap path exist between hosts A and B.

(Information Processing Apparatus)

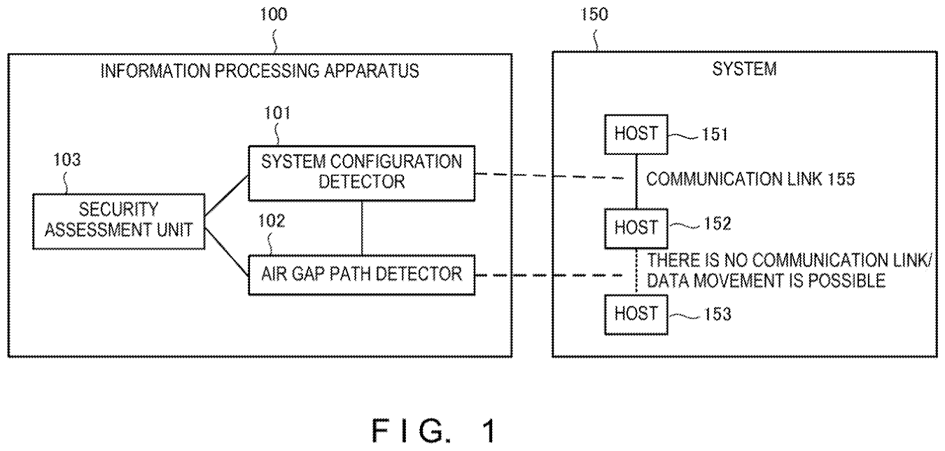

An information processing apparatus 100 according to the first example embodiment of the present invention will be described with reference to FIG. 1. The information processing apparatus 100 is an apparatus that assesses and evaluates a security state in a system.

As shown in FIG. 1, the information processing apparatus 100 includes a system configuration detector 101, an air gap path detector 102, and a security assessment unit 103.

The system configuration detector 101 detects at least two hosts 151 to 153 included in a system 150, and a communication link 155 between at least two hosts 151 and 152.

The air gap path detector 102 detects, among the at least two hosts 151 to 153, a pair of the hosts 152 and 153 between which there is no communication link but data movement may occur.

The security assessment unit 103 performs security assessment using the detection result by the system configuration detector 101 and that by the air gap path detector 102.

As described above, assessment can be performed in consideration of a situation in which a host that cannot be reached no matter how communication links existing on the network are followed is attacked from a given host.

### Second Example Embodiment

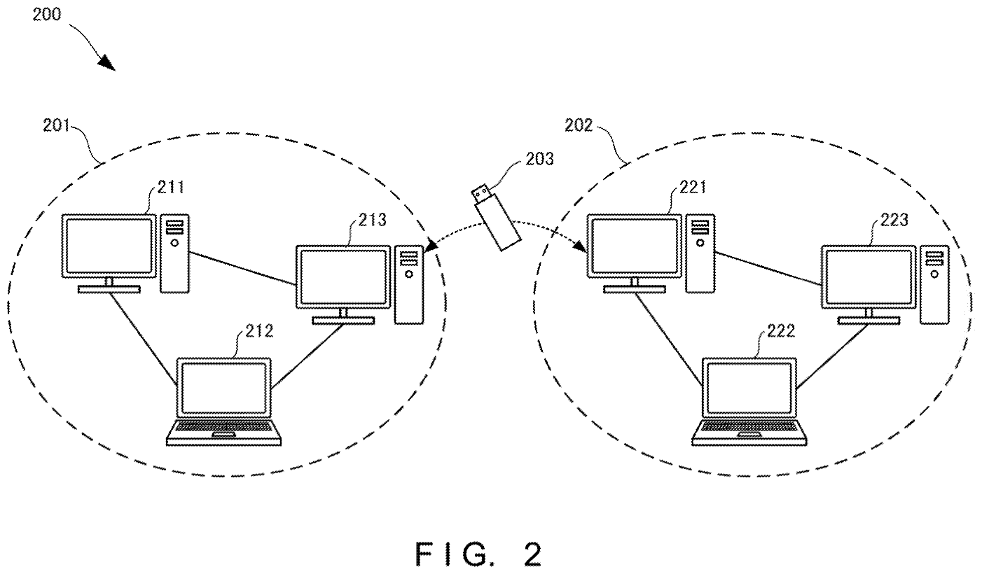

A security assessment system according to the second example embodiment of the present invention will be described next with reference to FIGS. 2 to 6.

(Configuration of System as Evaluation Target)

FIG. 2 is a view for explaining the configuration of a system 200 as an evaluation target of the security assessment system according to this example embodiment.

In this example, the system 200 as an assessment target includes host groups 201 and 202 each including normal reachable hosts. The host group 201 includes hosts 211 to 213, and the host group 202 includes hosts 221 to 223. The system 200 further includes an air gap path component 203. The hosts 211 to 213 in the normal reachable host group 201 are hosts that can reach each other by following communication links between the hosts. The same applies to the normal reachable host group 202, and the hosts 221 to 223 can reach each other by following communication links. There is no communication link between the host of the host group 201 and the host of the host group 202 regardless of wired or wireless connection. However, the air gap path component 203 connected to both the hosts 213 and 221 exists between them.

The hosts 211 to 213 and 221 to 223 are typically computers such as a PC and a server or network devices such as a firewall and a switch but are not limited to them, and may be peripheral devices such as a printer and a mouse or industrial control devices. The air gap path component 203 is typically a storage medium such as a USB memory but is not limited to this.

The security assessment system aims at making it possible to assess an attack path including an air gap path. For example, the host 211 is connected to an external network, and an attack path such that a target attack action is made in the host 223 by following 211→213→221→222→223 is assessed. In this case, 213→221 is an air gap path, and is not considered in existing security assessment.

(Configuration of Security Assessment System)

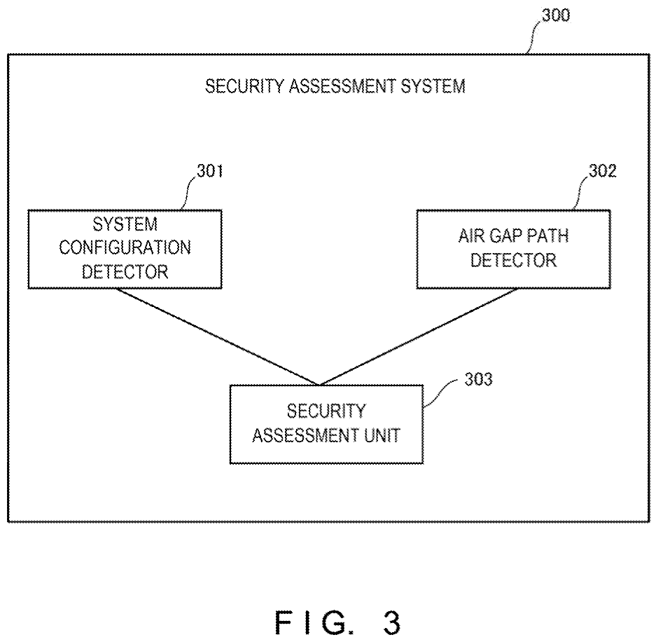

FIG. 3 shows an example of the configuration of a security assessment system 300. The security assessment system 300 includes a system configuration detector 301, an air gap path detector 302, and a security assessment unit 303.

The system configuration detector 301 is a functional unit that detects the configuration of a target system to undergo security assessment. The system configuration detector 301 detects at least hosts included in the assessment target system and a network configuration (the connection relationship between the hosts). By using the detected information, it is possible to determine the normal reachable host group 201. The security assessment unit 303 is notified of the information detected by the system configuration detector 301. In addition, the system configuration detector 301 may collect further information to be used for security assessment. For example, the system configuration detector 301 can collect information of software operating on each host, the version of the software, data saved in each host, credential information, a host accessed by the software of each host, a protocol between the hosts, the configuration information of the protocol, and the like.

The system configuration detector 301 is implemented by various implementation methods but can typically be implemented by introducing agent software (not shown) into each host. The agent software installed in each host notifies the security assessment system 300 of information of the host and its adjacent host with which the host can communicate. Although not shown in FIG. 3, an interface that allows the user to input a system configuration may be provided. Furthermore, it is possible to obtain information from an existing configuration management system.

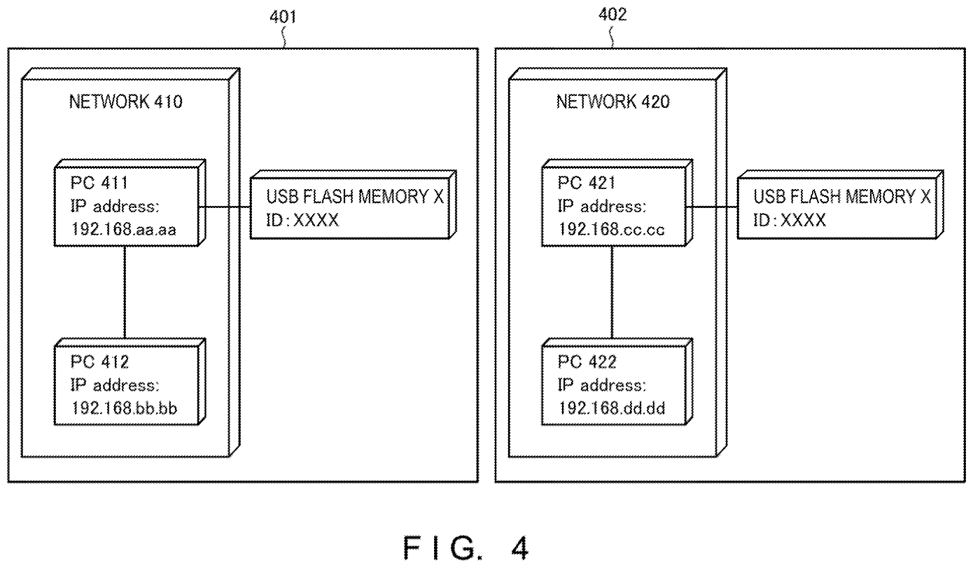

On the other hand, the system configuration detector 301 may detect a system configuration from a document concerning system specifications. That is, the existence of each host (PC 411, 412, 421, or 422), its identification information (device name or IP address), and a connection relationship may be detected as the system configuration from a layout 401 or 402 shown in FIG. 4. This collects information only from an input document, and it is thus possible to prevent the communication load of information collection on the actual system.

The air gap path detector 302 is a functional unit that allows the user to input air gap path information. The air gap path detector 302 provides the user with an interface for inputting air gap path information. At least information of the pieces of identification information of hosts forming an air gap path is input. For example, in the system 200 shown in FIG. 2, the pieces of identification information of the hosts 213 and 221 are input. The air gap path detector 302 notifies the security assessment unit 303 of the input air gap path information. At this time, the air gap path detector 302 may also notify the security assessment unit 303 of the identification information of the air gap path component 203. When a plurality of air gap path components 203 are connected to a single pair of hosts to form a plurality of air gap paths, these air gap paths can be distinguished from each other.

Furthermore, the air gap path detector 302 can include an interface that makes it possible to input information unique to an air gap path. For example, information of the frequency at which the air gap path component 203 is connected to hosts at the two ends of the air gap path, a time during which the air gap path component 203 is continuously connected, or a connection time such as a total connection time during a unit period can be input. Since it is considered that as the frequency at which the air gap path component is connected is higher or the connection time is longer, the air gap path is used for an attack more easily, it is important to allow such information to be input.

Furthermore, it is possible to provide an interface that makes it possible to input information concerning the type of the air gap path component 203. As for the air gap path component 203, various variations such as a USB memory, a smartphone, and a digital camera can be considered. Since it is considered that the usability of the air gap path for an attack changes depending on the type of the air gap path component 203, it is important to allow the air gap path component 203 to be input.

As for the air gap path component 203, there exist various variations. Any device having a storage function and capable of exchanging information with a host can serve as the air gap path component 203. Practical examples are a USB memory, a memory card such as an SD memory card, an external hard disk, an optical medium such as a CD or DVD, a laptop personal computer, a smartphone, a tablet, a digital camera, and a portable music player. A peripheral device such as a printer or a mouse or an industrial control device can also serve as the air gap path component 203. These devices are merely examples, and the present invention is not limited to them.

The air gap path may not include the air gap path component 203. That is, the hosts are connected directly by a cable without intervention of a storage medium or the hosts are temporarily connected by the Wi-Fi tethering function or the like. When the hosts are stationarily connected, no air gap path is formed. However, a path between the hosts that are temporarily connected by a system user, as needed, can be an air gap path. Such air gap path is also missed by the existing security assessment system. In this case, although the entity of the air gap path component 203 is eliminated, it is possible to input air gap information as in this example embodiment, and this example embodiment is applicable. Note that it is also possible to determine an air gap path by regarding the air gap path component 203 as a host.

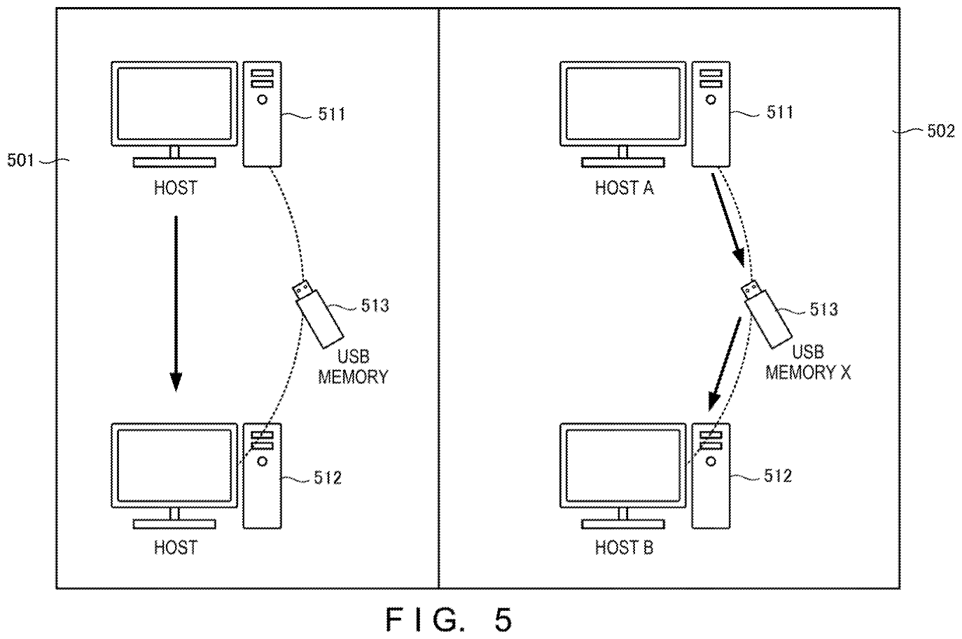

Consider a case in which a USB memory 513 is connected to hosts 511 and 512 as in a case 501 or 502 shown in FIG. 5. At this time, as shown in the case 501, it is possible to make the user input an air gap path by considering the USB memory 513 as the air gap path component 203 and assuming the existence of the air gap path between the hosts 511 and 512. On the other hand, as shown in the case 502, it is possible to make the user input air gap paths by considering the USB memory 513 as a host, and assuming the existence of the air gap paths between the host 511 and the USB memory 513 and between the USB memory 513 and the host 512. In the case 502, each of the air gap paths between the host 511 and the USB memory 513 and between the USB memory 513 and the host 512 is an air gap path with no air gap path component.

The air gap path detector 302 can input information concerning the direction of the air gap path. Considering, for example, a situation in which after the USB memory is initialized surely, hosts A and B are connected in the order named, malware may be infected from host A to host B but malware is never infected from host B to host A. Thus, a one-way air gap path from host A to host B is formed.

The security assessment unit 303 performs security assessment based on the pieces of information notified from the system configuration detector 301 and the air gap path detector 302. The security assessment unit 303 has at least a function of extracting an attack path from a given host to another host. As a simple method, if host A can reach host B by following the communication links on the network and the air gap paths, and some function of host B can be used illegally, all paths along which host A reaches host B can be extracted as an attack path from host A to host B.

With respect to each extracted attack path, the possibility that an attack is actually made, the possibility that damage is caused when an attack is made, a required attack time, and the like may be evaluated. At this time, the information of the connection frequency of the air gap path component 203, the connection time, and the type of the air gap path component 203 obtained from the air gap path detector 302 can be used.

Note that the security assessment unit 303 is not limited to the above-described functions. The security assessment unit 303 can appropriately be combined with an assessment method used in the existing security assessment system.

(Processing Procedure)

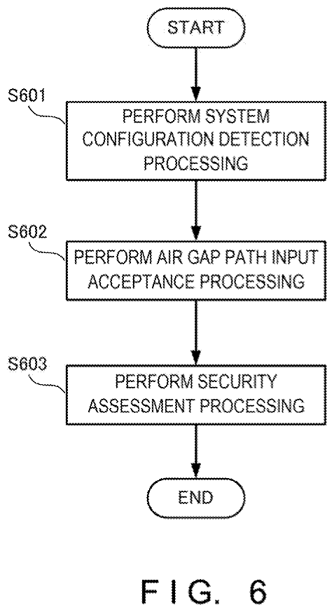

FIG. 6 shows a processing procedure according to this example embodiment. Note that processing shown in FIG. 6 can be performed by appropriately interchanging the order.

In step S601, the system configuration detector 301 performs system configuration detection processing to detect system information. The system configuration detector 301 notifies the security assessment unit 303 of the detected information.

In step S602, the air gap path detector 302 performs air gap path input acceptance processing to wait for the input of information from the user. If the input of air gap path information is received from the user, the security assessment unit 303 is notified of the information.

Lastly, in step S603, the security assessment unit 303 performs security assessment processing to extract an attack path including an air gap path.

According to this example embodiment, an air gap path that is not considered by the existing security assessment system can be included as an element of security assessment. That is, it is possible to extract an attack path including an air gap path that has been missed so far.

Furthermore, the connection frequency, connection time, and type of the air gap path component 203 can be reflected on security assessment.

### Third Example Embodiment

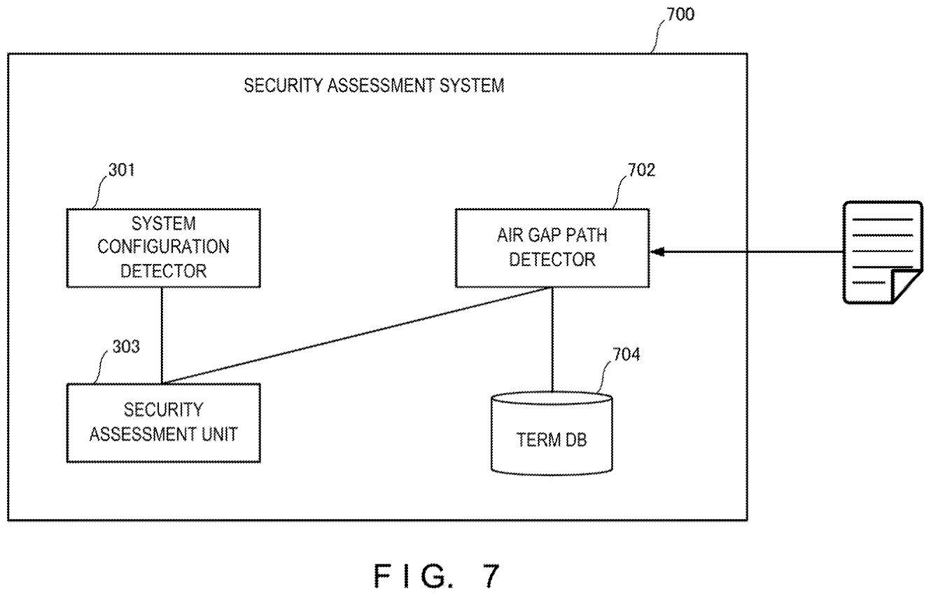

A security assessment system according to the third example embodiment of the present invention will be described next with reference to FIG. 7 and subsequent drawings. A security assessment system 700 according to this example embodiment is different from the above-described second example embodiment in that a term database 704 is provided. The remaining components and operations are similar to those in the second example embodiment. Hence, the same reference numerals denote the similar components and operations, and a detailed description thereof will be omitted.

The second example embodiment has explained the method of obtaining the air gap path information by making the user input the air gap path. To the contrary, in this example embodiment, air gap path information is acquired from a document.

(Configuration of Security Assessment System)

FIG. 7 is a block diagram for explaining the schematic configuration of the security assessment system according to this example embodiment. As compared with the second example embodiment, the function of an air gap path detector 702 is changed. In addition, the term database (term DB) 704 for interpreting information described in a document is provided.

The air gap path detector 702 has a function of extracting air gap path information from an input document and notifying a security assessment unit 303 of the information. As the document input to the air gap path detector 702, a document concerning system specifications or an operation manual can be used.

When extracting information of an air gap path component 203 from the input document, the air gap path detector 702 uses the term DB 704 to interpret a representation in the document. More specifically, information of a string representation that can represent the air gap path component 203 is stored in the term DB 704 in advance, and compared with words in the document to extract the information of the air gap path component 203. Contents stored in the term DB 704 may be a string of “USB flash memory”, “laptop PC”, or the like, or a representation such as a regular expression that can pattern-match a string.

The air gap path detector 702 extracts a device connected to a host as a candidate of the air gap path component 203 from the input document using the term DB 704. At this time, the extracted information includes at least the identification information of the candidate of the air gap path component 203 and the identification information of the host connected to the device. After that, if there exists a candidate of the air gap path component 203 connected to a plurality of hosts, the device is determined as the air gap path component 203 and it is determined that there is an air gap path between the hosts connected to the device.

For example, a layout 401 or 402, shown in FIG. 4, in UML (Unified Modeling Language) can be used as the input document. FIG. 4 shows layouts of networks 410 and 420 isolated on a system. Note that the existence of PCs 411, 412, 421, and 422, their IP addresses, and the fact that the PCs 411 and 412 can communicate with each other and the PCs 421 and 422 can communicate with each other are already found by a system configuration detector 301. Assume that a string “USB flash memory” is registered in the term DB 704 in advance as a word indicating the air gap path component 203.

The air gap path detector 702 compares each word existing in the layout with the contents of the term DB 704, recognizes, as a candidate of the air gap path component 203, a device indicated by a matching string, and acquires information of the device. At this time, the acquired information includes at least the identification information of the device and the pieces of identification information of hosts connected (connected by a solid line on the layout) to the device.

In the example shown in FIG. 4, since “USB flash memory” matches as a word indicating the air gap path component 203 in each of the layouts 401 and 402, identification information (ID: xxxx) is acquired. Note that if no identification information explicitly exists, identification information can be created based on information such as a device name (USB flash memory X). Typically, the string of the device name in the layout can be used intact as identification information (in FIG. 4, “USB flash memory X”). Furthermore, in the layout 401, an IP address “192.168.aa.aa” is acquired as information capable of identifying the host PC 411 to which USB flash memory X is connected. Similarly, in the layout 402, a device name “PC 421” or an IP address “192.168.cc.cc” is acquired as information capable of identifying the host PC 421 to which USB flash memory X is connected.

Note that values in various formats such as an explicitly designated ID, device name, host name, and IP address can be used as identification information, and the format of the identification information of the candidate of the air gap path component 203 may be different from the format of the identification information of the host. However, all the pieces of identification information of candidates of the air gap path component 203 are required to be extracted in the same format. Similarly, all the pieces of identification information of the hosts are required to be extracted in the same format.

The overall layout is loaded and a device recognized as a candidate of the air gap path component 203 at a plurality of locations is extracted again. In the example shown in FIG. 4, USB flash memory X is extracted. An air gap path is extracted based on the information of the host to which USB flash memory X is connected. In the example shown in FIG. 4, detection is performed by assuming the existence of an air gap path between the PCs 411 and 421. That is, data is generated to find information of a pair of hosts between which an air gap path exists, such as (“PC 411”, “PC 421”) or 192.168.aa.aa, 192.168.cc.cc). The security assessment unit 303 is notified of the generated data.

As another example, an air gap path can be read from an operation manual. When reading an air gap path from the operation manual, an air gap path detector 302 desirably includes a natural language processing engine.

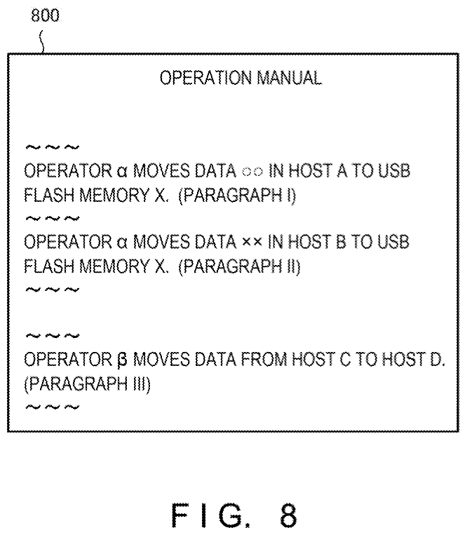

An example of reading an air gap path from an operation manual 800 will be described with reference to an example shown in FIG. 8. When reading an air gap path from the operation manual, there are provided a method of reading pieces of information of the hosts and information of the air gap path component 203 and a method of reading pieces of information of the hosts and information of an operator who operates the hosts.

Note that string information that can represent each of hosts 211 to 213 and 221 to 223, the air gap path component 203, and the operator is stored in the term DB 704 in advance. In the following description, the string information stored in the term DB 704 is used in extraction of each element included in the document.

In the method of reading the pieces of information of the hosts 211 to 213 and 221 to 223 and the information of the air gap path component 203, information of a pair of the information of one of the hosts 211 to 213 and 221 to 223 and the candidate of the air gap path component 203 is extracted from the operation manual using the natural language processing engine. At this time, any natural language processing algorithm can be used. As a simple method, if both a word representing one of the hosts 211 to 213 and 221 to 223 and a word representing the air gap path component 203 are included in one paragraph or one sentence, they can be extracted. As an advanced method, the natural language processing engine may be configured to recognize a sentence indicating that the air gap path component 203 is connected to one of the hosts 211 to 213 and 221 to 223, such as “data is moved from host A to memory X” or “data in host A is backed up to memory X”.

For example, in paragraph I of the operation manual 800, “host B” is extracted as the information of the host and “USB flash memory X” is extracted as the information of the air gap path component 203. Similarly, in paragraph II, “host A” is extracted as the information of the host and “USB flash memory X” is extracted as the information of the air gap path component 203.

Note that there is a variation in which a pair of the extracted information of the host and the extracted information of the candidate of the air gap path component 203 is considered as air gap path information and the security assessment unit 303 is notified of it.

As for the overall operation manual 800, if pairs each formed by one of the hosts 211 to 213 and 221 to 223 and the candidate of the air gap path component 203 are extracted, a device recognized as the candidate of the air gap path component 203 at a plurality of locations is extracted again (USB flash memory X in FIG. 4), as in the case in which the air gap path is recognized from the layout. Assuming that there exists an air gap path between the hosts to which the extracted air gap path component 203 is connected, data of a pair (“host A” and “host B” in the operation manual 800) of the pieces of identification information of the hosts is generated. As described above, the security assessment unit 303 is notified of the generated data.

The method of reading the pieces of information of the hosts 211 to 213 and 221 to 223 and the information of the operator who operates the hosts 211 to 213 and 221 to 223 will be described next. This method has a merit that an air gap path can be detected even in a situation in which a device used to exchange data between the hosts is not explicitly indicated.

In this method, a pair of information of one of the hosts 211 to 213 and 221 to 223 and the information of the operator who operates one of the hosts 211 to 213 and 221 to 223 is extracted using the natural language processing engine. Similar to the above-described method, any natural language processing algorithm can be used. As a simple method, if both a word representing one of the hosts 211 to 213 and 221 to 223 and a word representing the operator are included in one paragraph or one sentence, they can be extracted. As an advanced method, the natural language processing engine may be configured to recognize a sentence indicating that a given operator accesses the plurality of hosts 211 to 213 and 221 to 223 to move data.

In the example of the operation manual 800, a pair of “operator α” and “host A” in paragraph I and a pair of “operator α” and “host B” in paragraph II are extracted as pairs each formed by one of the hosts 211 to 213 and 221 to 223 and the operator. Furthermore, in paragraph III, a pair of “operator β” and “host C” and a pair of “operator β” and “host D” are extracted.

As for the overall operation manual, if the pairs each formed by the host and the operator are extracted, the operator extracted at a plurality of locations is extracted again (operators a and 13 in the operation manual 800). Assuming that there exists an air gap path between the hosts operated by the same operator, a pair of the hosts extracted together with the operator is generated as data indicating an air gap path. In the example of the operation manual 800, each of the pair of “host A” and “host B” extracted together with operator α and the pair of “host C” and “host D” extracted together with operator β is generated as data indicating an air gap path. As described above, the security assessment unit 303 is notified of the generated data.

To prevent a path between the hosts, which is originally not an air gap path, from being erroneously recognized as an air gap path, the operation manual may be separated on one page, paragraph, or sentence basis and the above processing may be repeatedly performed. In this case, if operations performed by the same operator are described in locations away from each other in the operation manual, the path between the hosts is not recognized as an air gap path, thereby reducing erroneously recognized air gap paths.

Representations that can be compared with strings for extracting the hosts 211 to 213 and 221 to 223, the air gap path component 203, and the operators are stored in the term DB 704, as needed. Typically, strings indicating the hosts 211 to 213 and 221 to 223, the air gap path component 203, and the operators are stored. A representation such as a regular expression that can pattern-match a string may be stored.

Note that a set of words representing the air gap path component 203, the hosts 211 to 213 and 221 to 223, and the operators can be different depending on the industry or contents of a system. For example, an office work system of a corporation includes, as hosts, many devices used in an office environment such as a “personal computer”, “authentication server”, and “printer”. A system of a factory includes, as hosts, many industrial control devices such as a “PLC”, “HMI”, and “engineering station”. Therefore, the term DB 704 may be customized for each industry in which the system is used. In addition, the user may be able to customize the contents of the term DB 704 and a method of interpreting a document in an air gap path detector 702.

In addition to the configuration shown in FIG. 7, a security assessment system 300 can be configured to include an interface that makes it possible to add, delete, or change a word, the interpretation rule of the document, and the contents of the term DB 704.

(Processing Procedure)

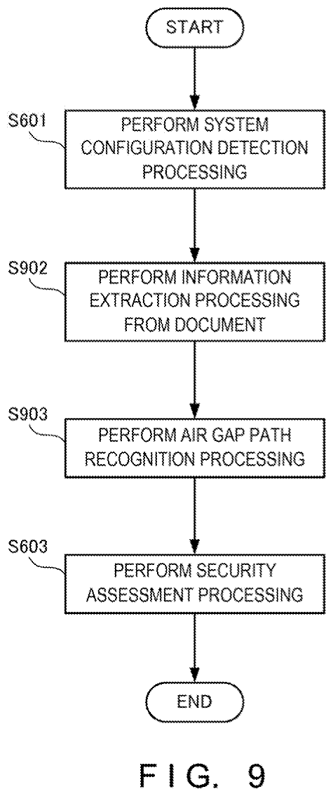

FIG. 9 shows a processing procedure according to this example embodiment. Note that processing shown in FIG. 9 can be performed by appropriately interchanging the order.

An operation according to this example embodiment includes system configuration detection processing S601, information extraction processing S902 from a document, air gap path recognition processing S903, and security assessment processing S603. The system configuration detection processing S601 and the security assessment processing S603 are the same as in the second example embodiment and a description thereof will be omitted.

In the information extraction processing S902 from the document, the air gap path detector 702 performs processing of extracting information of the air gap path component 203 and the hosts 211 to 213 and 221 to 223 connected to the air gap path component 203 or information of an operator and the hosts 211 to 213 and 221 to 223 operated by the operator.

In the air gap path recognition processing S903, an air gap path is detected based on the information of the air gap path component 203 and the connected hosts 211 to 213 and 221 to 223 or the information of the operator and the hosts 211 to 213 and 221 to 223 operated by the operator, which has been obtained in the information extraction processing S902 from the document, thereby generating data including at least information of a pair of hosts.

(Modification of this Example Embodiment)

In air gap path detection by the air gap path detector 702, an air gap path may be recognized directly by the natural language processing algorithm. That is, as in paragraphs I, II, and III of the operation manual 800, the natural language processing engine may be configured to directly detect the existence of an air gap path from a sentence indicating the existence of the air gap path.

Alternatively, extension can be performed to obtain air gap path information from a sentence, drawing, or table using an arbitrary machine learning engine that is not limited to natural language processing. That is, data of a sentence, drawing, or table that can form an air gap path is learned as correct answer data, and then the air gap path may be extracted directly from a sentence, drawing, or table in an input document.

In the explanation of this example embodiment, after the information of the air gap path component 203 or the operator is linked with the hosts to extract the information, a pair of hosts between which there is an air gap path is extracted again. However, the air gap path component 203 or the operator may not be indicated explicitly.

Therefore, the natural language processing engine may be configured to detect a sentence including the meaning of “moving data from given host to another host”, and an air gap path may be detected by assuming the existence of the air gap path between the pair of hosts.

In the above explanation of this example embodiment, the example of using the layout as the input document and the example of using the operation manual as the input document have been described. However, other documents may be used. For example, a UML use case diagram can be used. If a use case diagram is used, an air gap path can be detected from actors and contents described in use cases. In this case, among the contents described in use cases, a host with a use case described as a representation “move data to memory” indicating that a storage medium is connected to the host and a corresponding actor are extracted, and it can be determined that an air gap path exists between hosts connected to the storage medium by the same actor.

Other documents may be able to be usable as the input document in the same manner. For example, documents such as a sequence diagram, collaboration diagram, class diagram, object diagram, activity diagram, state chart diagram, and component diagram can also be used. A plurality of documents can also be used in combination appropriately.

However, after a representation indicating that the air gap path component 203 is connected to a host, it is necessary to be able to uniquely identify the connected air gap path component 203 and the connection destination host. In a representation form included in UML, a common item concerning a plurality of entities may be modeled depending on the way of writing, and thus the air gap path component 203 and the connection destination host may not be uniquely determined. In such document, only the single air gap path component 203 existing in the system and the single host existing in the system are entities that can be recognized as an air gap path.

As another example, a data flow diagram can be used. In this case, an air gap path is detected by associating the network configuration detected by the system configuration detector 301 with data movement between the hosts. That is, the air gap path detector 302 extracts, from a data flow diagram, a pair of hosts between which data is moved. In extraction of the pair of hosts, a pair of pieces of identification information of hosts connected by a line such as an arrow indicating data movement on the data flow is extracted. Note that at this time, hosts can be extracted using the information stored in the term DB 704 as in another example. If the extracted pair of hosts are normal unreachable hosts in the network configuration detected by the system configuration detector 301, an air gap path is detected by assuming the existence of the air gap path between the pair of hosts. Similar to the first example embodiment, the information of the type of the air gap path component 203 can be collected and used for security assessment. In this case, when extracting a candidate of the air gap path component 203, the type of the device is extracted simultaneously.

Furthermore, as in the first example embodiment, information of the connection frequency or connection time of the air gap path component 203 can be collected and used for security assessment. In this case, when extracting a candidate of the air gap path component 203, information of the connection frequency or connection time of the device is extracted simultaneously.

Similar to the first example embodiment, the air gap path may not include the air gap path component 203. For example, the data movement indicated in paragraph III of FIG. 8 is not always performed via the storage medium. That is, this example embodiment is not limited to the air gap path with the air gap path component 203, and an air gap path when hosts are connected directly by a cable or wireless communication can also be detected.

Similar to the second example embodiment, an air gap path can be determined by considering the air gap path component 203 as a host. That is, information of a pair of a host and a storage medium connected to the host may be extracted from a document and the security assessment unit 303 may be notified of it.

For example, assuming the existence of an air gap path between PC A and USB flash memory X or between PC C and USB flash memory X in FIG. 4, the security assessment unit 303 may be notified of a pair of the identification information of PC A and that of USB flash memory X or a pair of the identification information of PC C and that of USB flash memory X.

According to this example embodiment, it is possible to automatically acquire air gap path information using a document in which the specifications of the assessment target system are described or the operation manual of the system.

### Fourth Example Embodiment

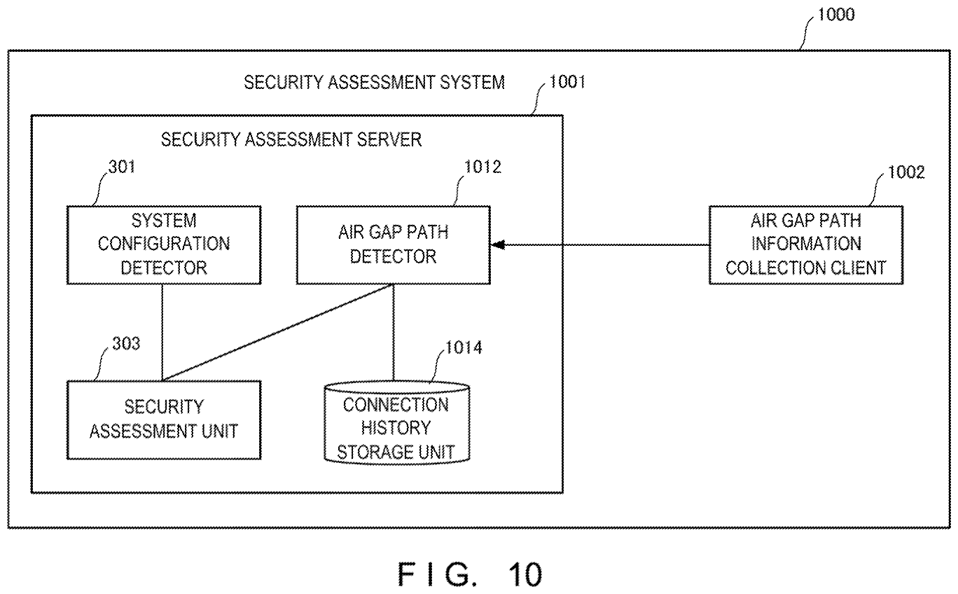

A security assessment system according to the fourth example embodiment of the present invention will be described next with reference to FIG. 10 and subsequent drawings. FIG. 10 is a block diagram for explaining the schematic configuration of the security assessment system according to this example embodiment. A security assessment system 1000 according to this example embodiment is different from the above-described second example embodiment in that an air gap path information collection client 1002 and a connection history storage unit 1014 are provided. The remaining components and operations are similar to those in the second example embodiment. Hence, the same reference numerals denote the similar components and operations, and a detailed description thereof will be omitted.

In the third example embodiment, the air gap path information is acquired based on the information loaded from the document. However, in this example embodiment, air gap path information is collected from an actual system.

(Configuration of Security Assessment System)

FIG. 10 is a block diagram for explaining the schematic configuration of the security assessment system 1000 according to this example embodiment. The security assessment system 1000 includes a security assessment server 1001 and the air gap path information collection client 1002. The security assessment server 1001 includes a system configuration detector 301, an air gap path detector 1012, a security assessment unit 303, and the connection history storage unit 1014. The air gap path detector 1012 obtains information for detecting an air gap path from the air gap path information collection client 1002.

The functions of the system configuration detector 301 and the security assessment unit 303 are the same as in the second example embodiment and a description thereof will be omitted.

The air gap path information collection client 1002 is typically agent software installed in a host. In the following explanation, a case in which the air gap path information collection client 1002 is agent software installed in a host will be described. The present invention, however, is not limited to this.

The air gap path information collection client 1002 has a function of detecting connection of an air gap path component 203 and notifying the air gap path detector 1012 of connection information of the air gap path component 203. More specifically, if it is detected that the air gap path component 203 is connected to the host in which the air gap path information collection client 1002 is installed, an air gap path detector 302 is notified of information including at least the identification information of the air gap path component 203 and the identification information of the host as connection information of the air gap path component 203.

Note that if there is provided a system of detecting connection of an external storage medium or the like by an existing security tool or configuration management tool and collecting the information, the collected information may be used. Alternatively, information of a system that records an operation history of an operator may be used.

The air gap path detector 1012 obtains the connection information of the air gap path component 203 from the air gap path information collection client 1002, and stores it in the connection history storage unit 1014. Furthermore, the air gap path detector 1012 detects an air gap path based on information already stored in the connection history storage unit 1014, and notifies the security assessment unit 303 of the air gap path.

More specifically, if the air gap path detector 1012 obtains the connection information of the air gap path component 203 from the air gap path information collection client 1002, it stores the information in the connection history storage unit 1014. At the same time, the air gap path detector 1012 acquires, from the connection history storage unit 1014, past connection information of the air gap path component having information of the same identification information of the air gap path component 203 as that of the air gap path component 203 included in the stored information. That is, the identification information of the host to which the same air gap path component 203 was connected in the past is obtained.

The air gap path detector 1012 detects an air gap path by assuming the existence of the air gap path between the host whose identification information is included in the connection information obtained from the air gap path information collection client 1002 and the host whose identification information is included in the connection information obtained from the connection history storage unit 1014. The security assessment unit 303 is notified of information of the detected air gap path. The information of the air gap path of which the security assessment unit 303 is notified includes at least the pieces of identification information of the hosts forming the air gap path.

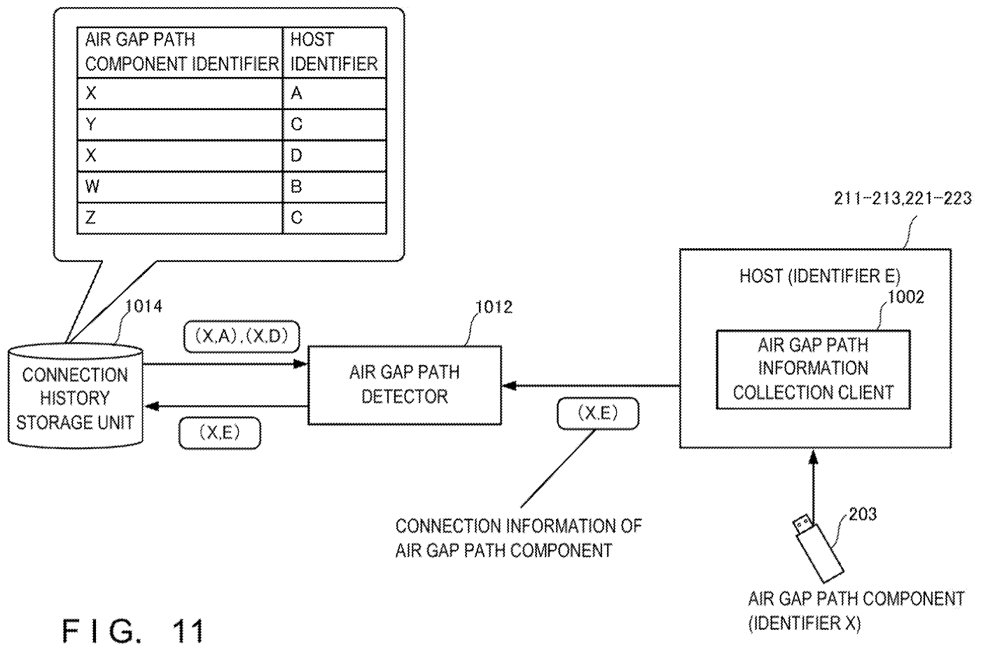

With reference to FIG. 11, a description will be provided using a practical example indicated by the connection history storage unit 1014 and an air gap path. Note that in the following explanation, for the sake of simplification, a host having identification information N will simply be referred to as host N hereinafter and an air gap path component having identification information M will simply be referred to as air gap path component M hereinafter. FIG. 11 shows an example in which air gap path component X is connected to host E. At this time, the air gap path information collection client 1002 in host E notifies the air gap path detector 1012 of information including at least identification information X and identification information E as connection information of the air gap path component. The air gap path detector 1012 stores the information in the connection history storage unit 1014, and also extracts connection information of the air gap path component having identification information X from the connection history. In the example shown in FIG. 11, (X, A) and (X, D) are extracted. This means that air gap path component X was connected to hosts A and D in the past. The air gap path detector 1012 detects air gap paths by assuming the existence of the air gap paths between hosts E and A and between hosts E and D, and notifies the security assessment unit of the pairs (E, A) and (E, D) of pieces of identification information.

The connection history storage unit 1014 stores the connection information of the air gap path component 203 collected from the air gap path information collection client 1002 by the air gap path detector 1012. The stored information is used in subsequent processing by the air gap path detector 1012.

(Processing Procedure)

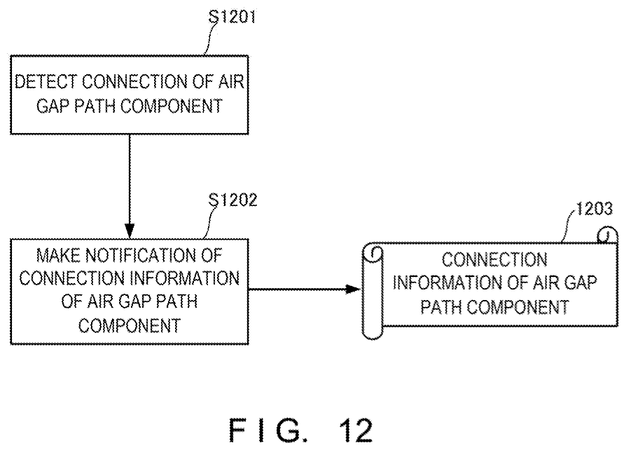

FIG. 12 shows a processing procedure in the air gap path information collection client 1002. If, in step S1201, the air gap path information collection client 1002 detects connection of the air gap path component, it notifies, in step S1202, the air gap path detector 1012 of connection information (1203) of the air gap path component.

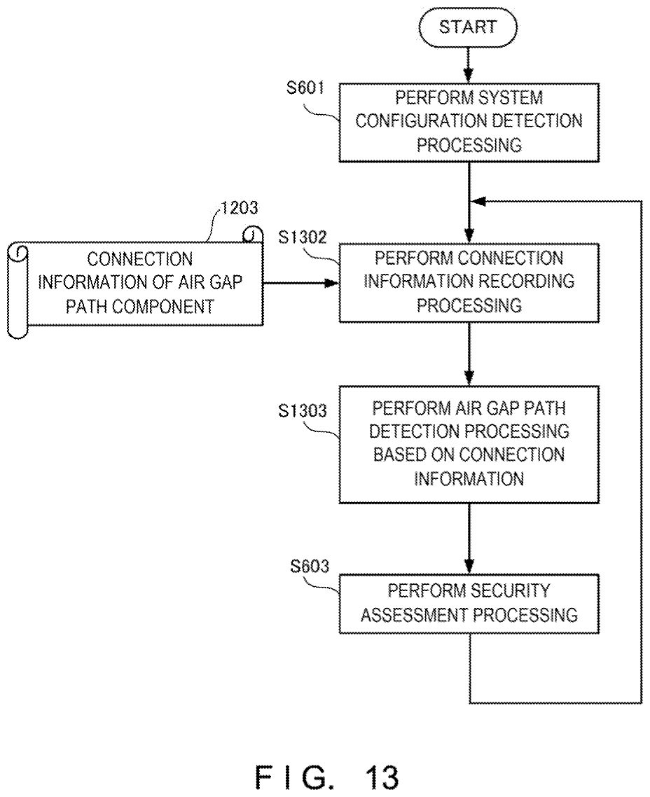

Next, FIG. 13 shows the operation of the security assessment server 1001. System configuration detection processing S601 and security assessment processing S603 are the same as in the second example embodiment and a description thereof will be omitted.

In step S1302, as connection information recording processing, the air gap path detector 1012 receives the connection information 1203 of the air gap path component 203 from the air gap path information collection client 1002. The received information 1203 is saved in the connection history storage unit 1014.

In step S1303, air gap path detection processing is performed based on the connection information. That is, information of a host to which the air gap path component was connected in the past is obtained from the connection history storage unit 1014, an air gap path is recognized, and the security assessment unit 303 is notified of it.

After the security assessment processing (S603) ends, the state transitions to a state of waiting for reception of the next connection information 1203 of the air gap path component (the process returns to step S1302).

Note that the security assessment server may repeatedly execute the processes in steps S1302 to S603 every time the connection information 1203 of the air gap path component is obtained, or the connection information 1203 of the air gap path component may be buffered and then the processes in steps S1302 to S603 may be executed every time a predetermined number of pieces of connection information 1203 are collected.

According to this example embodiment, it is possible to automatically detect an air gap path without requiring an input from the user, and include it in security assessment. Furthermore, a document for detecting an air gap path is not required. In this example embodiment, since information of an actually connected air gap path component is collected, an air gap path according to the actual state can be detected. In addition, it is possible to collect information in real time.

### Modifications and Supplements

When the air gap path component 203 is connected, the air gap path information collection client 1002 can send a time stamp in addition to the identification information of the air gap path component and that of the host. At this time, the air gap path detector 1012 can store the time stamp information in the connection history storage unit 1014 together. By storing the time stamp information, it is possible to prevent the connection information of the air gap path component before predetermined time from being used to detect an air gap path.

Similar to the first to third example embodiments, it is possible to collect information of the type of the air gap path component 203 and use it for security assessment. In this case, information obtained by linking the identification information of the air gap path component with the type of the air gap path component is preferably held in advance in the security assessment server 1001.

Furthermore, similar to the first to third example embodiments, it is possible to collect information of the connection frequency or connection time of the air gap path component 203 and use it for security assessment. In this case, the air gap path information collection client 1002 is made to measure the connection frequency or connection time of the air gap path component 203 to notify the air gap path detector 302 of it.

Similar to the first and second example embodiments, an air gap path may include no air gap path component 203. That is, in this example embodiment, the air gap path information collection client 1002 may record temporary connection of another host in addition to connection of the air gap path component 203, and notify the air gap path detector 1012 of it. In this case, similar to a case in which a notification of the connection information of the air gap path component 203 is made, the air gap path detector 1012 can record a connection history and detect an air gap path. That is, in this example embodiment as well, it is possible to detect an air gap path obtained by temporarily connecting hosts by a cable directly or by wireless communication without including the air gap path component 203.

Similar to the second example embodiment described with reference to FIG. 5, it is possible to determine an air gap path by considering the air gap path component 203 as a host. In this case, the security assessment unit 303 may be notified of the connection information notified from the air gap path information collection client 1002 intact. That is, it is also possible to prevent the use of the connection history storage unit 1014.

If the air gap path information collection client 1002 is installed in each host and information is collected from these clients, normal unreachable hosts may become reachable by communication between the air gap path information collection client 1002 and the air gap path detector 1012. For example, a situation is considered in which the security assessment server 1001 communicates with the hosts 213 and 221 in FIG. 2 to obtain information from the air gap path information collection clients 1002 installed in the hosts 213 and 221. In this case, the hosts 213 and 221 may become reachable via a computer mounted with the security assessment server 1001. That is, it can be said that an attack may be executed via the computer mounted with the security assessment server 1001.

To prevent such attack, when obtaining information from the air gap path information collection client 1002, one-way communication can be performed. For example, by using a data diode, it is possible to send data from the air gap path information collection client 1002 to the security assessment server 1001. In this case, it is possible to prevent data (malware or the like) from being transmitted from the computer mounted with the security assessment server 1001 to the host in which the air gap path information collection client 1002 is installed. The present invention is not limited to the data diode, and any mechanism for allowing information to be transmitted only in one way is used.

A similar problem may arise in information collection in the system configuration detector 301. In this case as well, it is possible to prevent a situation, in which an attack is made via a computer mounted with a security assessment system, by using a similar mechanism for allowing only one-way communication in information collection for implementing the processing of the system configuration detector 301.

As for the air gap path information collection client 1002, there exist various variations. The air gap path information collection client 1002 can be mounted on the air gap path component 203. For example, if the air gap path component 203 is a device having a function as a computer such as a smartphone or a note PC, it is possible to mount the air gap path information collection client 1002 in the device.

In this case, if the air gap path information collection client 1002 detects connection of the host, it notifies the air gap path detector 302 of the security assessment server of the identification information of the air gap path component and the identification information of the connected host. By mounting the air gap path information collection client 1002 on the air gap path component 203 in this way, it is unnecessary to mount a function for security assessment on the host. Since installation of new software may be restricted with respect to the host as part of the assessment target system, it is effective for such case to mount the air gap path information collection client 1002 in the air gap path component 203.

Furthermore, it is possible to implement the air gap path information collection client 1002 by an external device. For example, it is possible to attach, to a host, a sensor having a communication function of monitoring an interface communicable with an external device, such as the USB port of the host. When the interface is used, the sensor notifies the air gap path detector 302 of information concerning the connected air gap path component 203 using wireless communication or the like. At this time, a device having a communication function is also attached to the air gap path component 203, and the sensor may obtain, from the device, information of the identification information of the connected air gap path component 203. If the air gap path component 203 is a device having a communication function, such as a smartphone or a laptop PC, information of the identification information of the air gap path component 203 may be obtained directly from the air gap path component 203. Note that it is also possible to attach a sensor having a communication function to the air gap path component 203.

It is also possible to perform detection in consideration of the direction of an air gap path. For example, if the connection history storage unit 1014 records the fact that air gap path component X is connected to host A, and then connected to host B, it is possible to detect a directional air gap path by assuming that a one-way air gap path exists in a direction from host A to host B.

### Other Modifications

The example of detecting an air gap path by assuming the existence of the air gap path between hosts temporarily connected via a storage medium, a communication cable, or the like by operational manipulation has mainly been explained. However, a condition for detecting a path as an air gap path can be relaxed. For example, the condition for detecting a path as an air gap path can be relaxed so as to detect, as an air gap path, a path between hosts having physical interfaces of the same type. Note that the physical interface includes an apparatus that writes/reads data in/from a storage medium, such as an optical drive.

As a practical example, it can be detected that air gap paths exist between all hosts each having a USB port. The same applies to other physical interfaces. This relaxing corresponds to identifying all hosts that can form air gap paths. In assessment assuming that a malicious inside criminal forms an air gap path, information of all hosts that can form air gap paths may become necessary. Note that detection of an air gap path can be limited to normal unreachable hosts.

The above relaxing can be performed in all the above-described example embodiments. In the second example embodiment, it is possible to provide an interface capable of inputting information of a pair of hosts having physical interfaces of the same type or the physical interface of each host. In the third example embodiment, it is possible to extract, from a document concerning the interfaces of the hosts among documents concerning the system specifications, the physical interfaces of the hosts detected by the system configuration detector 301. Detection is performed by assuming the existence of an air gap path between the hosts with physical interfaces to which the same air gap path component can be connected. In the fourth example embodiment, it is possible to cause the air gap path information collection client 1002 to notify the air gap path detector 302 of information of the physical interface of the host in which the air gap path information collection client 1002 is installed. Detection is performed by assuming the existence of an air gap path between hosts with physical interfaces to which the same air gap path component can be connected.

Furthermore, there is another method of relaxing the condition for detecting an air gap path. For example, an air gap path may be detected based on an area where an operator can enter. In the third example embodiment, it is possible to extract an area where each operator can enter and hosts existing in the area, and perform detection by assuming the existence of an air gap path between the hosts.

As another example, an air gap path may be detected based on a region where the air gap path component 203 moves. In the fourth example embodiment, if the air gap path component 203 is brought into a specific indoor room, it can be determined that the air gap path component 203 is connected to all hosts existing in the room. This determines that there exist air gap paths between all the hosts to which the air gap path component 203 can physically be connected. More specifically, a sensor capable of acquiring position information is attached to the air gap path component 203, and the air gap path detector 302 is notified of information of the sensor. In addition, the position information of each host is held in the security assessment server 1001 in advance. This makes it possible to grasp the positional relationship between the air gap path component 203 and each host. If the positional relationship with a given host satisfies a determined criterion, it is determined that the air gap path component 203 is connected to the host. Examples of the criterion of the positional relationship are that the host and the air gap path component 203 exist in an indoor partitioned region (a room or the like) and that the linear distance is equal to or shorter than a threshold.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims. A system or apparatus including any combination of the individual features included in the respective example embodiments may be incorporated in the scope of the present invention.

That is, a security assessment system including a plurality of levels at which an air gap path is detected can be adopted. For example, the present invention incorporates a system including a plurality of air gap path detection methods of (1) to (4) below.

(1) A method of performing detection using an actual connection history, as in the fourth example embodiment

(2) A method of performing detection based on a document, as in the third example embodiment

(3) A method of performing detection by assuming the existence of an air gap path between hosts existing an area where a specific operator can enter

(4) A method of performing detection by assuming the existence of air gap paths between all hosts with physical interfaces of the same type

The detection methods of (1) to (4) can be interpreted as the following detection levels.

(1) An air gap path whose existence is actually confirmed on the system

(2) An air gap path formed during an operation

(3) An air gap path that can be formed by an inside criminal with entry authority into a partial section of a place where the system is installed

(4) An air gap path that can be formed by an inside criminal with entry authority into all places where the system is installed

Note that the detection level can also be considered as air gap path detection sensitivity.

The security assessment system including the plurality of air gap path detection methods (detection levels) can include an interface for designating the air gap path detection method (detection level). This interface can be called an interface for designating the air gap path detection sensitivity.

The present invention is applicable to a system including a plurality of devices or a single apparatus. The present invention is also applicable even when an information processing program for implementing the functions of example embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described example embodiments.

1. An information processing apparatus comprising:
a system configuration detector that detects at least two hosts included in a system and a communication link between the at least two hosts;
an air gap path detector that detects, among the at least two hosts, a pair of hosts between which there is no communication link but data movement can occur; and
a security assessment unit that performs security assessment using a detection result by said system configuration detector and a detection result by said air gap path detector.

2. The information processing apparatus according to claim 1, wherein said air gap path detector includes an interface for inputting, by a user, information concerning the pair of hosts detected by said air gap path detector.

3. The information processing apparatus according to claim 1, wherein said air gap path detector detects the pair of hosts detected by said air gap path detector, based on information of a document concerning specifications of the system.

4. The information processing apparatus according to claim 1, wherein said air gap path detector detects the pair of hosts detected by said air gap path detector, based on information of an operation manual of the system.

5. The information processing apparatus according to claim 3, further comprising an interface for inputting an interpretation rule of a word or a text to extract, from the document or the operation manual, information of an element that can cause data movement to occur.

6. The information processing apparatus according to claim 1, wherein information concerning a type of the element that can cause data movement to occur between the pair of hosts detected by said air gap path detector is collected.

7. The information processing apparatus according to claim 1, wherein information concerning a frequency or a connection time at which or during which the element that can cause data movement to occur between the pair of hosts detected by said air gap path detector is connected to the host or information concerning both the frequency and the connection time is collected.

8. (canceled)

9. A security assessment method comprising:
detecting at least two hosts included in a system and a communication link between the at least two hosts;
detecting a pair of hosts between which there is no communication link but data movement can occur, among the at least two hosts; and
performing security assessment using a detection result obtained in the detecting the at least two hosts and a detection result obtained in the detecting the pair of hosts.

10. A non-transitory computer readable medium storing a security assessment program for causing a computer to execute a method, comprising:
detecting at least two hosts included in a system and a communication link between the at least two hosts;
detecting a pair of hosts between which there is no communication link but data movement can occur, among the at least two hosts; and
performing security assessment using a detection result obtained in the detecting the at least two hosts and a detection result obtained in the detecting the pair of hosts.
